(19) United States
(12) Patent Application Publication
(10) Pub. No.: US 2024/0239604 A1
(43) Pub. Date: Jul. 18, 2024

(54) Article Transport Facility

(71) Applicant: Daifuky Co., Ltd., Osaka-shi (JP)

(72) Inventors: Wataru Kiyokawa, Tokyo (JP); Hidenobu Shinnaka, Tokyo (JP); Hideki Sato, Tokyo (JP)

(21) Appl. No.: 18/412,837

(22) Filed: Jan. 15, 2024

(30) Foreign Application Priority Data
Jan. 16, 2023 (JP) 2023-004428

(51) Int. Cl. B65G 1/137; A47G 33/00; B65G 1/04

(52) U.S. Cl. CPC B65G 1/137; A47G 33/008; B65G 1/0407

(57) ABSTRACT

A second fork of a second transfer device includes a support section with a supporting surface for supporting an article, a fork disposition space disposed below the supporting surface such that a first fork projecting along a first advancing and retracting direction is disposed in the fork disposition space, and a communication section allowing the fork disposition space to communicate with an upper space above the supporting surface in an up-down direction. The first fork is passable through the communication section in the up-down direction.

### CROSS-REFERENCE TO RELATED APPLICATION

This application claims priority to Japanese Patent Application No. 2023-004428 filed Jan. 16, 2023, the disclosure of which is hereby incorporated by reference in its entirety.

### BACKGROUND OF THE INVENTION

### 1. Field of the Invention

The present invention relates to an article transport facility including a plurality of transfer devices each including a fork.

### 2. Description of Related Art

There has been known an article transport facility including a plurality of transfer devices each including a fork. Hereinafter, reference signs described within parentheses in the Description of the Related Art are reference signs used in Patent Literature 1. FIG. 3 and paragraph 0025 in Patent Literature 1 (Japanese Unexamined Patent Application Publication No. 2021-134076) discloses an article transport facility that includes a stacker crane (15) including a slide fork (161), and a forklift including a fork.

In the article transport facility of Patent Literature 1, a picking station on which an article is placed temporarily is provided between the stacker crane and the forklift. In the configuration using the picking station when the article is transferred from a fork to a fork, the article can be temporarily held by the picking station. This configuration has such an advantage that there is little restriction on respective operation timings of the forks or the like, and an article transfer operation or an article transport operation is easily and effectively performed. In the meantime, the picking station and a space where the picking station is disposed are required, so that it is difficult to achieve downsizing and simplification of the facility.

### SUMMARY OF THE INVENTION

In view of the foregoing, the article transport facility that transports an article by transferring the article from a fork to a fork is desired to have a configuration that easily achieves downsizing or simplification of the facility.

An article transport facility according to this disclosure includes: a first transfer device including a first fork configured to support an article from a lower side, a first advancing and retracting mechanism configured to advance and retract the first fork along a first advancing and retracting direction along a horizontal direction, and a first lifting and lowering mechanism configured to lift and lower the first fork; and at least one second transfer device including a second fork configured to support the article from the lower side, and a second advancing and retracting mechanism configured to advance and retract the second fork along a second advancing and retracting direction along the horizontal direction. The second fork includes at least one support section with a supporting surface for supporting the article, a fork disposition space disposed below the supporting surface such that the first fork projecting along the first advancing and retracting direction is disposed in the fork disposition space, and a communication section allowing the fork disposition space to communicate with an upper space above the supporting surface in an up-down direction. The first fork is passable through the communication section in the up-down direction. The at least one support section supports the article with a posture in which a supported surface, of the article, that faces downward intersects with a movement trajectory of the first fork passing through the communication section in the up-down direction.

With this configuration, it is possible to transfer the article directly from the first fork of the first transfer device to the second fork of the second transfer device. On that account, it is not necessary to provide a mounting section or the like for placing the article thereon temporarily, between the first transfer device and the second transfer device. Accordingly, it is possible to easily achieve downsizing of the article transport facility and simplification of its configuration.

### BRIEF DESCRIPTION OF THE DRAWINGS

FIG. 1 is a top view of an article transport facility;

FIG. 2 is a side view illustrating a state where a first fork supporting an article is at a travel position;

FIG. 3 is a side view illustrating a state where the first fork is above a first delivery position;

FIG. 4 is a view of the article transport facility in the state of FIG. 3 when it is viewed from a first space side;

FIG. 5 is a side view illustrating a state where the first fork is below the first delivery position;

FIG. 6 is a view of the article transport facility in the state of FIG. 5 when it is viewed from the first space side;

FIG. 7 is a side view illustrating a state where a second fork at a second delivery position supports the article;

FIG. 8 is a view of the article transport facility in the state of FIG. 7 when it is viewed from the first space side;

FIG. 9 is a side view illustrating a state where the article supported by the second fork is at an altar position; and

FIG. 10 is a sectional view corresponding to FIG. 6 and illustrating an article transport facility in another form.

### DESCRIPTION OF THE INVENTION

An embodiment of an article transport facility will be described below with reference to the drawings.

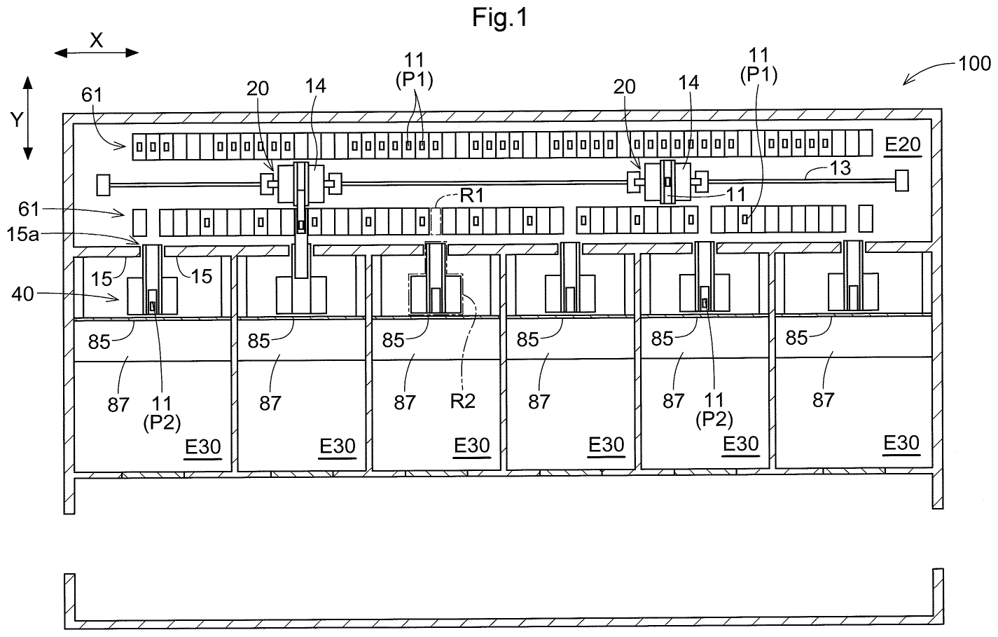

FIG. 1 is a plan view of an article transport facility 10 of the present embodiment and an institution 100 where the article transport facility 10 is provided. The institution 100 is not limited in particular but is a place of worship in the present embodiment. As another example, the institution 100 may be a factory, a warehouse, a vessel, and the like. In the present embodiment, the institution 100 includes a first space E20, a second space E30, and a partition wall 15 provided between the first space E20 and the second space E30. The partition wall 15 has an opening 15a through which an article 11 is moved. The partition wall 15 may include a door that can open and close the opening 15a, although not provided in the example illustrated herein. Examples of the first space E20 may be a storage space for storing the article 11, a clean room with a cleanliness lower than that of the second space E30, the outdoors, and the like. Examples of the second space E30 may be a machining space for the article 11, a display space, a prayer space, a clean room with a cleanliness higher than that of the first space E20, and the like.

The article transport facility 10 includes a first transfer device 20 and a second transfer device 40. In the present embodiment, the article transport facility 10 further includes a transport device 14 for moving the first transfer device 20 horizontally. In the example illustrated herein, the article transport facility 10 includes a plurality of first transfer devices 20. The article transport facility 10 includes a plurality of second transfer devices 40. The article transport facility 10 includes a plurality of transport devices 14.

Examples of the transport device 14 in the article transport facility 10 may be a tracked unmanned transport vehicle, a trackless unmanned transport vehicle, a manned transport vehicle, and the like. Note that the transport device 14 may be a device for moving the first transfer device 20 in an up-down direction Z, e.g., a lift, an elevator, or a crane. In the present embodiment, the transport device 14 is an unmanned transport vehicle configured to travel along a rail 13. Here, the up-down direction Z is defined as a direction along the vertical direction, a first direction X is defined as a direction perpendicular to the up-down direction Z, and a second direction Y is defined as a direction perpendicular to the first direction X in a top-bottom view.

In the present embodiment, the first transfer device 20 and the transport device 14 are configured to transport the article 11 between a predetermined first position P1 and the second transfer device 40. In the present embodiment, the first transfer device 20 is provided in a stacker crane. The transport device 14 is a travel wagon of the stacker crane. Examples of the first position P1 may be positions or the like provided in a storing section in a storage shelf, a delivery section of an article storage facility or the like, a loading space of the unmanned transport vehicle, a work table of the device, a display table, a prayer table, and the first transfer device 20. In the present embodiment, the first position P1 is provided on the first space E20 side relative to the partition wall 15.

In the present embodiment, the first position P1 is set in a plurality of storing sections for storing articles 11. The plurality of storing sections is provided in a storage shelf 61 included in the article transport facility 10. In the example illustrated herein, the first transfer device 20 is disposed on the first space E20 side relative to the partition wall 15. In the example illustrated herein, the transport device 14 is disposed on the first space E20 side relative to the partition wall 15.

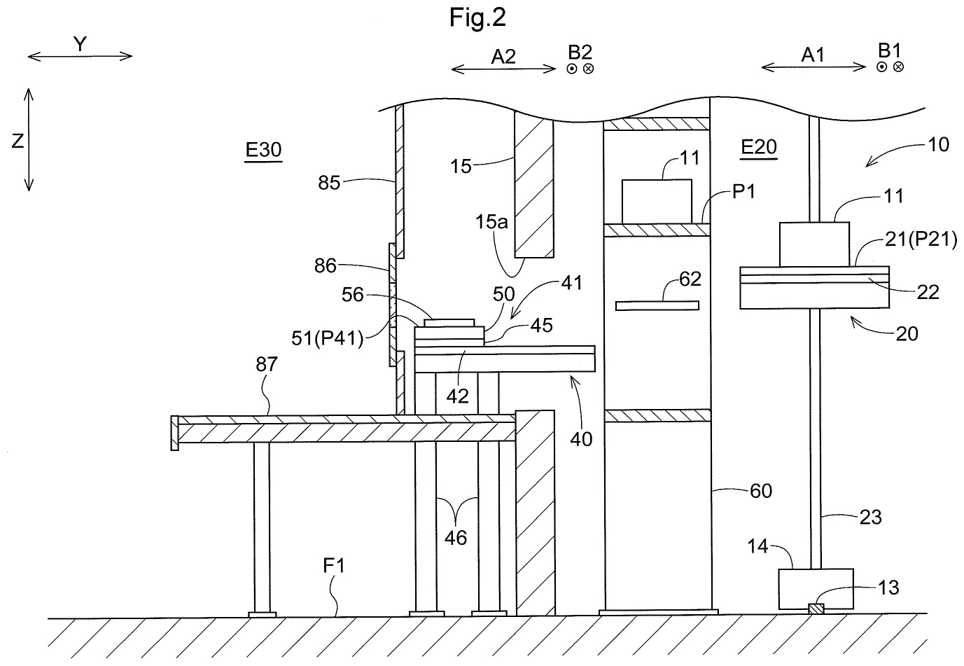

FIG. 2 is a side view of the article transport facility 10 with the first transfer device 20 supporting the article 11. As illustrated in FIG. 2, the first transfer device 20 includes a first fork 21 configured to support the article 11 from the lower side, a first advancing and retracting mechanism 22 configured to advance and retract the first fork 21 along a first advancing and retracting direction A1 along the horizontal direction, and a first lifting and lowering mechanism 23 configured to lift and lower the first fork 21. Here, a first neutral position P21 is defined as a position where the first fork 21 does not advance and retract to either side along the first advancing and retracting direction A1. In the present embodiment, the first neutral position P21 is a position (travel position) of the first fork 21 at the time when the transport device 14 travels along the rail 13. In FIG. 2, the first fork 21 is located at the first neutral position P21. Note that the “first fork” and a “second fork” (described later) are not limited to a scooping member having a distal end divided into a plurality of parts but also include a scooping member having only one distal end. That is, in the present specification, an advancing and retracting member that is advanced and retracted by an advancing and retracting mechanism and serves as a member for supporting an article from the lower side is referred to as a “fork,” and the “fork” is not limited to a particular shape. Therefore, the “first fork,” the “second fork,” a “fork body,” and a “fork disposition space” in the present specification can be rephrased as a “first advancing and retracting member,” a “second advancing and retracting member,” an “advancing and retracting member main body,” and an “advancing and retracting member disposition space,” respectively.

In the present embodiment, the second transfer device 40 is configured to transport the article 11 between the first transfer device 20 and a predetermined second position P2. Examples of the second position P2 may be positions or the like provided in the storing section of the storage shelf, the delivery section of the article storage facility or the like, the loading space of the unmanned transport vehicle, the work table of the device, the display table, the prayer table, and the second transfer device 40. In the present embodiment, the second position P2 is a position set on a second fork 41 of the second transfer device 40. In the example illustrated herein, the second position P2 is provided on the second space E30 side relative to the partition wall 15. In the example illustrated herein, the second transfer device 40 is fixed to a floor face F1 on the second space E30 side relative to the partition wall 15.

In the present embodiment, the second transfer device 40 transports the article 11 such that the volume of generated sound in an audible range is smaller than that of the first transfer device 20. In the present embodiment, the second transfer device 40 transports the article 11 such that the magnitude of generated vibrations is smaller than that of the first transfer device 20. With this configuration, in a case where the second space E30 is demanded to be small in volume of sound in the audible range or in vibration, the volume of sound in the audible range or the magnitude of vibration can be made small in the second space E30. In the present embodiment, advancing and retracting of the second fork 41 by a second advancing and retracting mechanism 42 in the second transfer device 40 are performed at a speed lower than the speed of advancing and retracting of the first fork 21 by the first advancing and retracting mechanism 22 in the first transfer device 20. With this configuration, it is possible to achieve the second transfer device 40 that is small in volume of sound in the audible range or in vibration at a low cost.

As illustrated in FIG. 2, the second transfer device 40 includes the second fork 41 configured to support the article 11 from the lower side, and the second advancing and retracting mechanism 42 configured to advance and retract the second fork 41 along a second advancing and retracting direction A2 along the horizontal direction. In the present embodiment, the first advancing and retracting direction A1 is parallel to the second advancing and retracting direction A2.

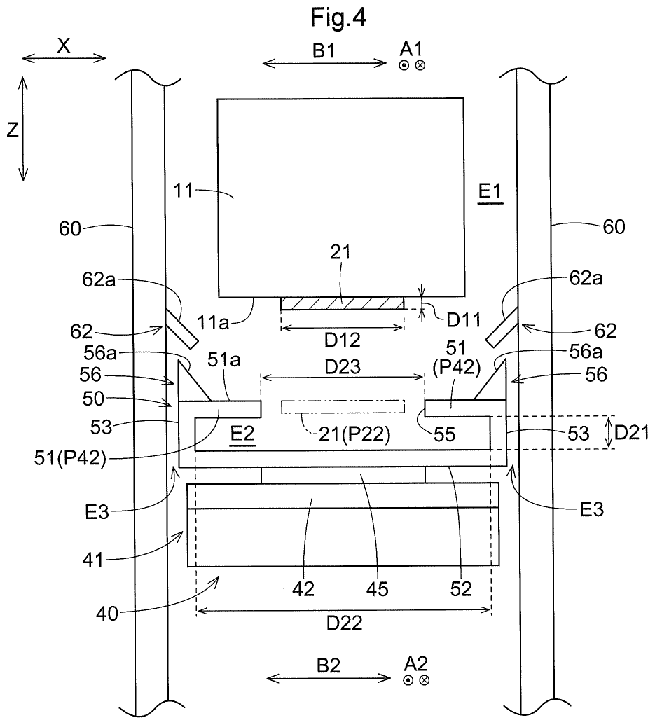

The second fork 41 of the second transfer device 40 includes a support section 51 forming a supporting surface 51a (see FIG. 4) supporting the article 11. Here, a second delivery position P42 is defined as a position of the second fork 41 of the support section 51 at which position the article 11 is delivered to or received from the first fork 21. In the present embodiment, the second delivery position P42 is provided on the first space E20 side relative to the partition wall 15. A first delivery position P22 is defined a position of the first fork 21 at which position the article 11 is delivered to or received from the second fork 41. The first delivery position P22 is a position of the first fork 21 at which position the supporting surface, of the first fork 21, that supports the article 11 is disposed at the same height as the supporting surface 51a of the support section 51 of the second fork 41. In the present embodiment, the first delivery position P22 is provided on the first space E20 side relative to the partition wall 15. When the position of the first fork 21 is the first delivery position P22, and the position of the support section 51 of the second fork 41 is the second delivery position P42, the article 11 delivered between the first fork 21 and the second fork 41 is supported by both the first fork 21 and the second fork 41.

Here, a reference stopping position is defined as a stopping position for the support section 51 at the time when the second transfer device 40 is stopped. In the example illustrated in FIG. 2, the reference stopping position is at a second neutral position P41 (described later). As illustrated in FIG. 1, in the present embodiment, the partition wall 15 is provided between the first position P1 and the second position P2, and the support section 51 is disposed on the second space E30 side relative to the partition wall 15 when the support section 51 stops at the reference stopping position (the second neutral position P41). With this configuration, in a case where repair of malfunction or maintenance is performed on the second transfer device 40, an operator can easily reach the second transfer device 40 from the second space E30 side relative to the partition wall 15. Accordingly, easiness in repair of malfunction or maintenance is easily raised.

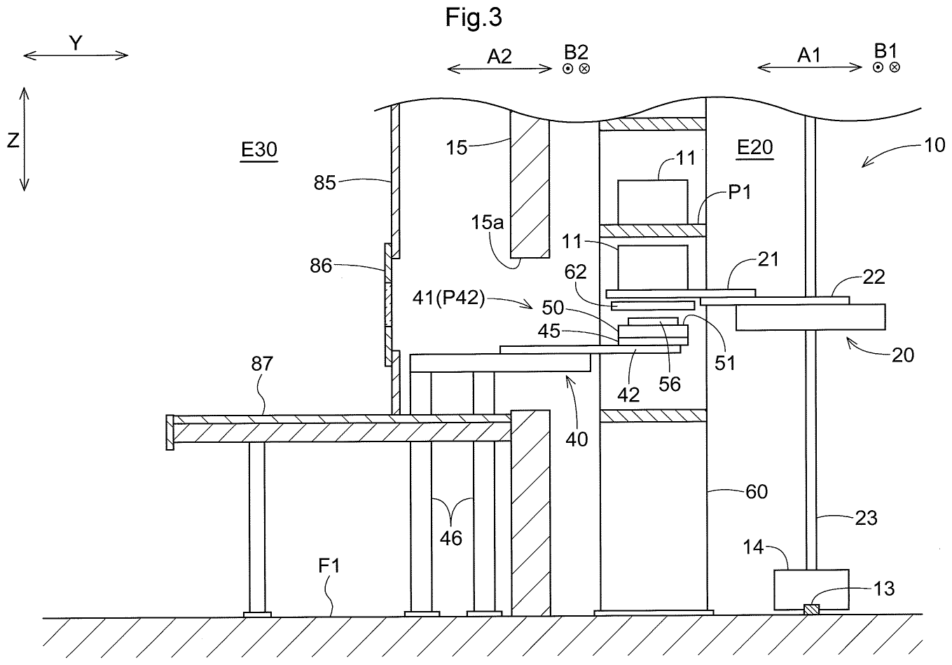

FIG. 3 is a side view of the article transport facility 10 when the first fork 21 is disposed above the first delivery position P22, and the support section 51 of the second fork 41 is disposed at the second delivery position P42. FIG. 4 is a view of the article transport facility 10 in the state of FIG. 3 when it is viewed from the first space E20 side. Here, a first width direction B1 is defined as a direction perpendicular to the first advancing and retracting direction A1 in a top-bottom view. A second width direction B2 is defined as a direction perpendicular to the second advancing and retracting direction A2 in a top-bottom view.

In the present embodiment, the support section 51 of the second fork 41 and the first fork 21 are configured to deliver or receive the article 11 to and from each other between a pair of fixed members 60 fixed to the floor face F1 and extending in the up-down direction Z. In the example illustrated herein, the pair of fixed members 60 are poles of the storage shelf 61 including a plurality of storing sections. In the present embodiment, the pair of fixed members 60 are included in the article transport facility 10.

As illustrated in FIG. 3, in the present embodiment, the first delivery position P22 and the second delivery position P42 are set between the pair of fixed members 60. The second delivery position P42 may be the second neutral position P41 where the second fork 41 does not advance and retract toward either side in the second advancing and retracting direction A2, but in the present embodiment, the second delivery position P42 is a position different from the second neutral position P41.

The second fork 41 of the second transfer device 40 includes the support section 51 with the supporting surface 51a for supporting the article 11, a fork disposition space E2 disposed below the supporting surface 51a such that the first fork 21 projecting along the first advancing and retracting direction A1 is disposed in the fork disposition space E2, and a communication section 55 allowing the fork disposition space E2 to communicate with an upper space E1 above the supporting surface 51a in the up-down direction Z. The communication section 55 is configured such that the first fork 21 is passable therethrough in the up-down direction Z. The support section 51 is configured to support the article 11 with a posture in which a supported surface 11b, of the article 11, that faces downward intersects with a movement trajectory of the first fork 21 passing through the communication section 55 in the up-down direction Z.

In the present embodiment, the support section 51 and the communication section 55 do not overlap with each other in a top-bottom view. In the present embodiment, the supported surface 11b is the bottom face of the article 11. In the present embodiment, a pair of support sections 51 are apart from each other to be disposed on opposite sides across the communication section 55 in the first width direction B1.

In the present embodiment, the second fork 41 includes a fork body 45 and a delivery assist member 50 attached to the fork body 45. The delivery assist member 50 includes the pair of support sections 51, a base section 52 disposed below the pair of support sections 51 to be apart from the pair of support sections 51, and a pair of connecting sections 53 connecting the pair of support sections 51 to the base section 52 in the up-down direction Z. The delivery assist member 50 is fixed to the fork body 45.

In the present embodiment, the fork disposition space E2 is defined by the pair of support sections 51, the pair of connecting sections 53, and the base section 52. A distance D21 in the up-down direction Z from a pair of supporting surfaces 51a to the top surface of the base section 52 is larger than a dimension D11 of the first fork 21 in the up-down direction Z. A distance D22 between the pair of connecting sections 53 in the first width direction B1 and a distance D23 between the pair of support sections 51 in the first width direction B1 are larger than a dimension D12 of the first fork 21 in the first width direction B1.

In the present embodiment, the second fork 41 includes a first guide section 56 attached to the support section 51 to project upward from the supporting surface 51a. The first guide section 56 guides the article 11 in the horizontal direction, while the article is being placed on the supporting surface 51a from above. In the present embodiment, the first guide section 56 is fixed to the support section 51. The first guide section 56 is configured to guide the article 11 only along the second width direction B2. More specifically, a pair of first guide sections 56 apart from each other to be disposed on the opposite sides in the second width direction B2 include respective first guide faces 56a directed downward as they go toward an inner side in the second width direction B2, the inner side in the second width direction B2 being defined as a side directed toward the center of the second fork 41 in the second width direction B2. The first guide sections 56 guide the article 11 in the second width direction B2 by contact actions of the first guide faces 56a to the article 11.

In the present embodiment, the pair of fixed members 60 are disposed on the respective opposite sides in the second width direction B2 with respective gaps E3 from the support sections 51 at the second delivery position P42. Respective second guide sections 62 are attached to the pair of fixed members 60. The pair of second guide sections 62 are disposed above the first guide sections 56 when the support sections 51 are at the second delivery position P42, such that the pair of second guide sections 62 overlap with the respective gaps E3 in a top-bottom view. The pair of second guide sections 62 are configured to guide the article 11, in the second width direction B2, while the article 11 is being placed on the supporting surfaces 51a from above the first guide section 56. In the present embodiment, the second delivery position P42 corresponds to a “delivery position.”

In the present embodiment, the second guide section 62 is fixed to the fixed member 60. The second guide section 62 is configured to guide the article 11 only along the second width direction B2. More specifically, the pair of second guide sections 62 disposed on the opposite sides in the second width direction B2 have respective second guide faces 62a directed downward as they go toward the inner side in the second width direction B2. The second guide sections 62 guide the position of the article 11 in the second width direction B2 by contact actions of the second guide faces 62a to the article 11. In the example illustrated herein, the second guide faces 62a are disposed such that their inner parts in the second width direction B2 overlap with respective parts on outer sides, in the second width direction B2, of the first guide faces 56a in a top-bottom view when the support sections 51 are at the second delivery position P42, the outer sides in the second width direction B2 being defined as sides opposite to the inner side in the second width direction B2.

With reference to FIG. 2 to FIG. 9 sequentially, the following describes an example of transferring of the article 11 from the first fork 21 of the first transfer device 20 to the second fork 41 of the second transfer device 40.

The article 11 taken by the first fork 21 out of the storing section at the first position P1 is supported by the first fork 21 at the travel position (the first neutral position P21) and moved by the transport device 14. The support section 51 of the second fork 41 that does not support the article 11 is at the second neutral position P41 as the reference stopping position. FIG. 2 illustrates this state. In the example illustrated herein, the first neutral position P21 is a position above the first delivery position P22.

Subsequently, the first fork 21 of the first transfer device 20 keeps supporting the article 11 and projects along the first advancing and retracting direction A1, and the first fork 21 moves to the upper space E1 above the supporting surface 51a, at generally the same position as the first delivery position P22 in a top-bottom view. The support section 51 of the second fork 41 of the second transfer device 40 projects toward the second delivery position P42 along the second advancing and retracting direction A2. FIGS. 3 and 4 illustrate this state. Note that, instead of advancing and retracting the first fork 21 at the same time as the second fork 41, either of the first fork 21 and the second fork 41 may advance and retract earlier, and the other one may advance and retract later. The first delivery position P22 of the first fork 21 is indicated by an alternate long and two short dashes line in FIG. 4.

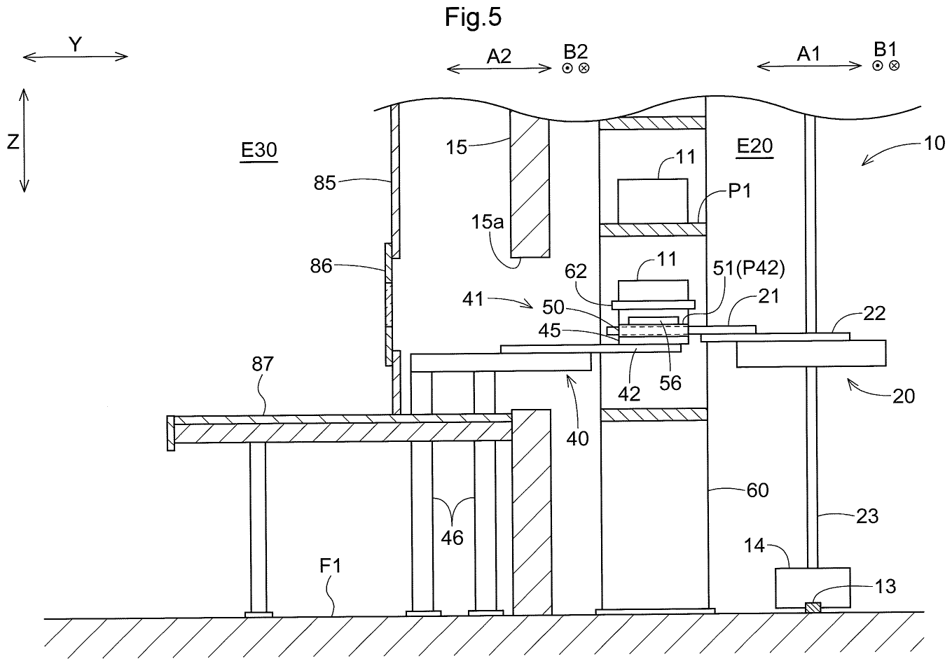

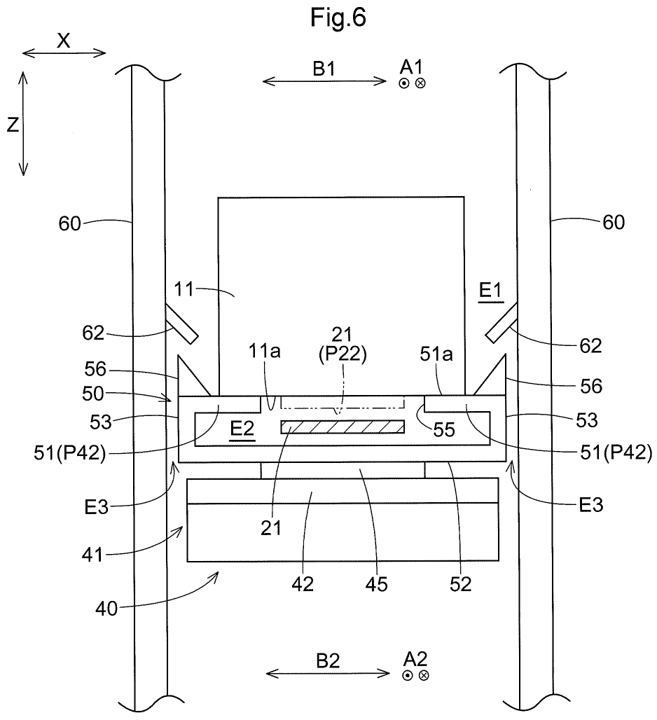

Subsequently, the first fork 21 of the first transfer device 20 is lowered from the space E1 and moved to the fork disposition space E2 at a position below the first delivery position P22. The first fork 21 of the first transfer device 20 keeps supporting the article 11 and passes through the first delivery position P22, so that the article 11 moves from the first fork 21 onto the support section 51 of the second fork 41 of the second transfer device 40. FIGS. 5 and 6 illustrate this state. At the time when the article 11 is lowered, if the position of the article 11 on the first fork 21 deviates to such an extent that the article 11 overlaps with the second guide section 62 in a top-bottom view, the article 11 makes contact with the second guide section 62, and subsequently, the article 11 makes contact with the first guide section 56, so that the position of the article 11 on the first fork 21 is guided to a position where the article 11 is supported by the pair of support sections 51 (more specifically, the pair of supporting surfaces 51a). Note that the first delivery position P22 of the first fork 21 is indicated by an alternate long and short dash line in FIG. 6.

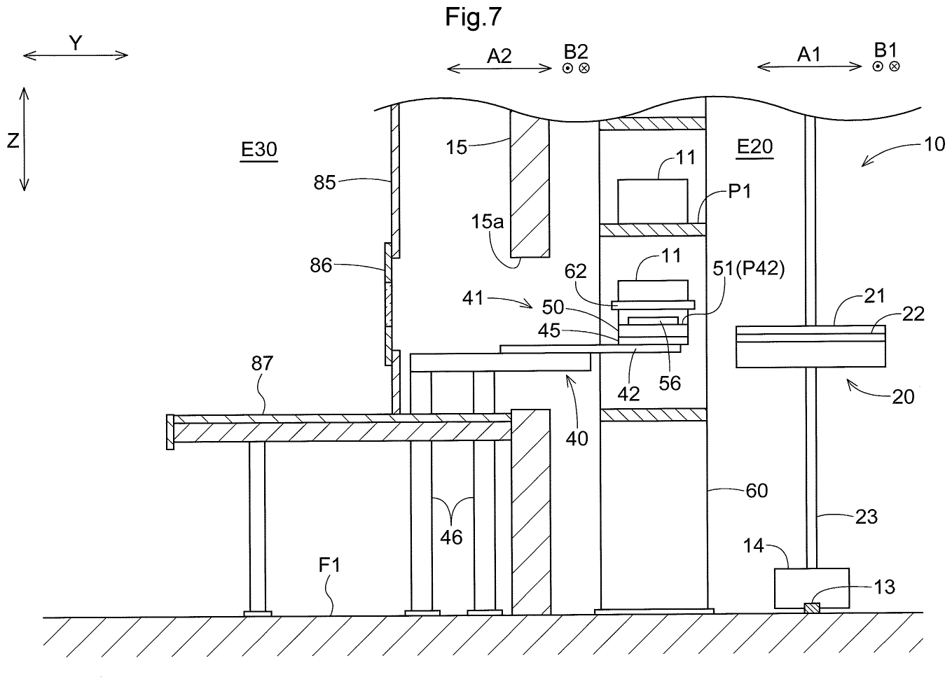

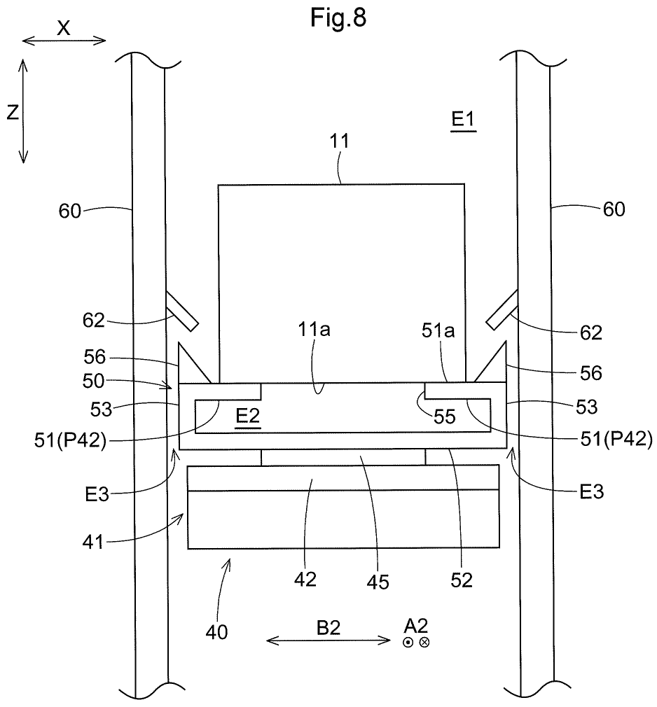

Then, the first fork 21 of the first transfer device 20 retracts along the first advancing and retracting direction A1 and moves to the travel position (the first neutral position P21). Hereby, the first fork 21 comes out of the fork disposition space E2 of the second fork 41. FIGS. 7 and 8 illustrate this state.

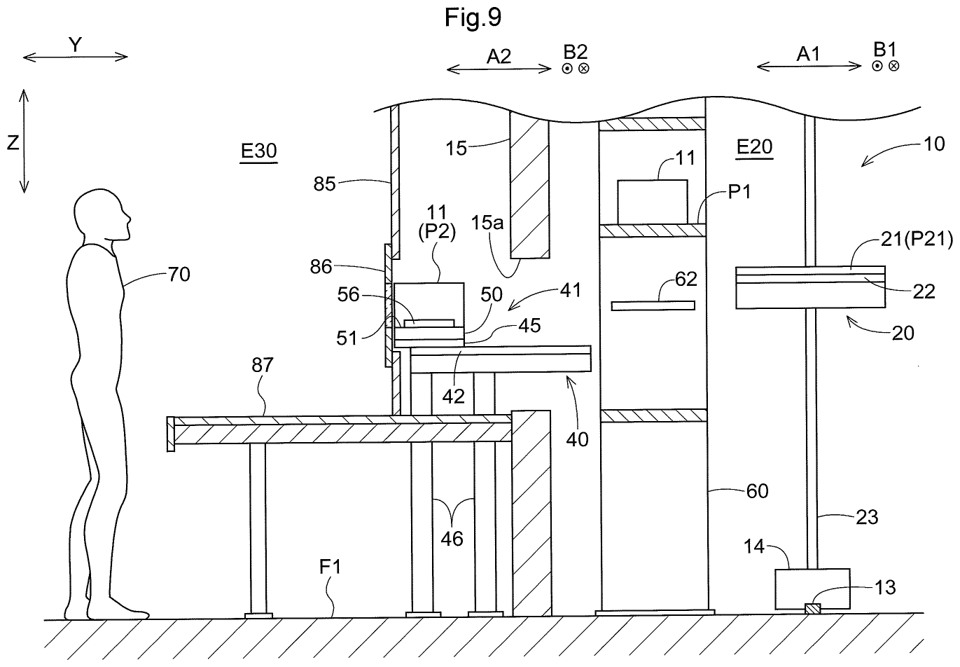

Subsequently, the support section 51 of the second fork 41 of the second transfer device 40 retracts along the second advancing and retracting direction A2, and further, the support section 51 projects to a position corresponding to the second position P2 of the article 11 across the second neutral position P41 (see FIG. 2). FIG. 9 illustrates this state. Note that the second fork 41 may advance and retract before the first fork 21 advances and retracts to the travel position (the first neutral position P21), or they may advance and retract at the same time.

With reference to FIG. 9 to FIG. 2 sequentially, the following describes an example of transferring of the article 11 from the second fork 41 of the second transfer device 40 to the first fork 21 of the first transfer device 20.

FIG. 9 illustrates a state where the article 11 is located at the second position P2. The support section 51 of the second fork 41 of the second transfer device 40 keeps supporting the article 11 retracts along the second advancing and retracting direction A2 from this state, and further, the support section 51 projects to the second delivery position P42 across the second neutral position P41 (see FIG. 2). FIGS. 7 and 8 illustrate this state.

Subsequently, the first fork 21 of the first transfer device 20 projects along the first advancing and retracting direction A1 and moves into the fork disposition space E2 of the second fork 41. FIGS. 5 and 6 illustrate this state. Note that the first fork 21 may advance and retract before the support section 51 of the second fork 41 advances and retracts to the second delivery position P42, or they may advance and retract at the same time.

Then, the first fork 21 of the first transfer device 20 is lifted from the fork disposition space E2 and moves to the upper space E1 above the supporting surface 51a. At this time, the first fork 21 of the first transfer device 20 passes through the first delivery position P22, so that the article 11 moves from the support section 51 of the second fork 41 onto the first fork 21. FIGS. 3 and 4 illustrate this state.

Then, the first fork 21 keeps supporting the article 11 and retracts along the first advancing and retracting direction A1, so that the first fork 21 moves to the travel position (the first neutral position P21). The support section 51 of the second fork 41 retracts along the first advancing and retracting direction A1 and moves to the reference stopping position (the second neutral position P41). FIG. 2 illustrates this state. Note that, instead of advancing and retracting the first fork 21 at the same time as the second fork 41, either of the first fork 21 and the second fork 41 may advance and retract earlier, and the other one may advance and retract later.

Referring back to FIG. 9, the article 11 is a prayer target object in the present embodiment. The first space E20 is a storeroom for storing the article 11. The second space E30 is a praying section where a visitant 70 prays. The second position P2 of the article 11 is an altar position for the prayer target object.

In the present embodiment, the second transfer device 40 is disposed at a position corresponding to the praying section (the second space E30). The first transfer device 20 and the transport device 14 are configured to transport the prayer target object (the article 11) between the second transfer device 40 and each of a plurality of storing sections (the first position P1) each storing the prayer target object (the article 11). The second transfer device 40 can dispose the prayer target object (the article 11) received from the first fork 21 and supported by the support section 51 to the altar position (the second position P2) set in the praying section (the second space E30) by advancing and retracting the second fork 41 by the second advancing and retracting mechanism 42.

In the present embodiment, the second transfer device 40 includes legs 46 fixed to the floor face F1 of the praying section (the second space E30). The second transfer device 40 is covered with a cover 85 in the praying section (the second space E30). The cover 85 includes a window-equipped door 86 through which the prayer target object (the article 11) can be taken out. The window-equipped door 86 includes a window through which a side face, of the prayer target object (the article 11), that faces the praying section (the second space E30) is observable. A table 87 usable by the visitant 70 at the time of praying is disposed below the window-equipped door 86. The praying section is constituted by a plurality of prayer rooms (second spaces E30) with different sizes, and the altar position (the second position P2) in each prayer room (each second space E30) is set in accordance with the specification of the each prayer room.

In the present embodiment, the first transfer device 20 is disposed on the storeroom (the first space E20) side relative to the partition wall 15. The second transfer device 40 is disposed on the praying section (the second space E30) side relative to the partition wall 15. The second transfer device 40 moves the prayer target object (the article 11) such that the volume of generated sound in the audible range and the magnitude of vibration are smaller than those of the first transfer device 20. With this configuration, it is possible to relatively decrease the volume of sound in the audible range and the magnitude of vibration in the praying section (the second space E30) required to be silent.

Here, the reference stopping position is defined as a stopping position for the support section 51 at the time of stopping the second transfer device 40. In the present embodiment, the partition wall 15 is provided between the storing section (the first position P1) and the altar position (the second position P2). While the support section 51 is stopped at the reference stopping position (the second neutral position P41), the support section 51 is disposed on the praying section (the second space E30) side relative to the partition wall 15.

Referring back to FIGS. 1 and 2, in the present embodiment, the whole second transfer device 40 with the support section 51 being stopped at the reference stopping position (the second neutral position P41) is in an arrangement region R2 that does not overlap with a region R1 sandwiched between the pair of fixed members 60 in a top-bottom view. Note that the arrangement region R2 of the whole second transfer device 40 with the support section 51 being stopped at the reference stopping position (the second neutral position P41) may be on the second space E30 side relative to the partition wall 15 in a top-bottom view.

In the present embodiment, a plurality of second transfer devices 40 is disposed within a moving range where the first transfer device 20 is moved by the transport device 14. Each of the second transfer devices 40 is configured to move the article 11 received from the first fork 21 by advancing and retracting the second fork 41 by the second advancing and retracting mechanism 42, such that the article 11 is moved to the second position P2 as a destination determined in advance to correspond to the each of the second transfer devices 40. In each of the second transfer devices 40, the second fork 41 is advanced and retracted by the second advancing and retracting mechanism 42 by an advancing and retracting amount set in accordance with the destination (the second position P2) and the installation position of the each of the second transfer devices 40.

In the present embodiment, the distance between the installation position of the second transfer device 40 and the partition wall 15 is set to be constant. A plurality of distances is set as the distance between the second position P2 of the article 11 and the partition wall 15.

### OTHER EMBODIMENTS

Next will be described other embodiments of the article transport facility 10.

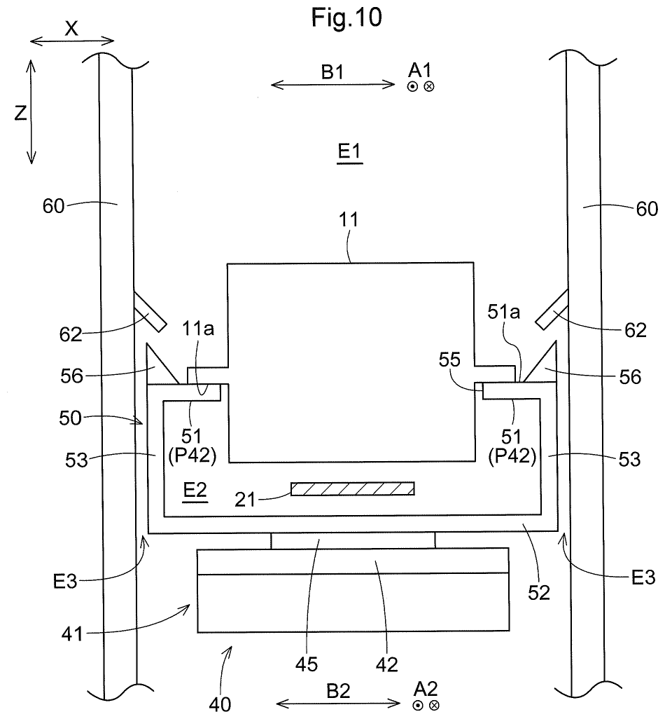

(1) The above embodiment has described, as an example, the configuration in which the supported surface 11b is the bottom face of the article 11. However, the present invention is not limited to such an example, and as illustrated in FIG. 10, for example, the supported surface 11b may be a bottom face of a flange-shaped part projecting from the side face of the article 11, or the like.

(2) The above embodiment has described, as an example, the configuration in which the first advancing and retracting direction A1 is parallel to the second advancing and retracting direction A2. However, the present invention is not limited to such an example, and the first advancing and retracting direction A1 may intersect with the second advancing and retracting direction A2. The direction of the delivery assist member 50 of the second fork 41 may be changed such that the first advancing and retracting direction A1 is perpendicular to the second advancing and retracting direction A2, for example.

(3) The above embodiment has described, as an example, the configuration in which the first transfer device 20 including the first lifting and lowering mechanism 23 is moved by the transport device 14 in at least either of the up-down direction Z and the horizontal direction, and the second transfer device 40 is fixed to the floor face F1. However, the present invention is not limited to such an example, and the first transfer device 20 including the first lifting and lowering mechanism 23 may be fixed to the floor face F1, and the second transfer device 40 may be moved by a transport device in at least either of the up-down direction Z and the horizontal direction, for example. The second transfer device 40 may include a second lifting and lowering mechanism configured to lift and lower the second fork 41. The first transfer device 20 may substantially include a lifting and lowering mechanism such that the first transfer device 20 is moved by the transport device 14 in the up-down direction Z.

(4) The above embodiment has described, as an example, the configuration in which the pair of fixed members 60 serve as poles of the storage shelf 61. However, the present invention is not limited to such an example, and the pair of fixed members 60 may be walls of the institution 100, column supports of a transfer device, other devices, or combinations thereof, for example. For example, the pair of fixed members 60 may be opposite surfaces of the opening 15a of the partition wall 15.

(5) The above embodiment has described, as an example, the configuration in which the first delivery position P22 and the second delivery position P42 are set between the pair of fixed members 60. However, the present invention is not limited to such an example, and the first delivery position P22 and the second delivery position P42 may be set at positions not between the pair of fixed members 60, for example. For example, the first delivery position P22 may be provided on the second space E30 side relative to the partition wall 15. For example, the second delivery position P42 may be provided on the second space E30 side relative to the partition wall 15.

(6) The above embodiment has described, as an example, the configuration in which the pair of support sections 51 are apart from each other to be disposed on the opposite sides across the communication section 55 in the first width direction B1. However, the present invention is not limited to such an example, and the first fork 21 may include a pair of supporting sections apart from each other to be disposed on the opposite sides in the first width direction B1, and the second fork 41 may include one support section 51 such that the fork disposition space E2 and the communication section 55 are provided on either side of the one support section 51, for example.

(7) The above embodiment has described, as an example, the configuration in which the second fork 41 includes the delivery assist member 50 including the support sections 51. However, the present invention is not limited to such an example, and the delivery assist member 50 may not include the base section 52, and the top surface of the fork body 45 may function as the top surface of the base section 52, for example. The second fork 41 may not include the delivery assist member 50, and the second fork 41 may have an upper part serving as the support section 51 such that the top surface of the second fork 41 serves as the supporting surface 51a.

(8) The above embodiment has described, as an example, the configuration in which the first neutral position P21 is the travel position, and the second neutral position P41 is the reference stopping position. However, the present invention is not limited to such an example, and the travel position may be a position different from the first neutral position P21, for example. The reference stopping position may be a position different from the second neutral position P41 and may be a position (the position of the support section 51 illustrated in FIG. 9) corresponding to the altar position of the article 11.

(9) The above embodiment has described, as an example, the configuration in which the first guide section 56 is fixed to the support section 51, and the second guide section 62 is fixed to the fixed member 60. However, the present invention is not limited to such an example, and the second fork 41 may not include the first guide section 56, for example. The second guide section 62 may not be attached to the fixed member 60.

(10) The above embodiment has described, as an example, the configuration in which the first guide section 56 guides the article 11 only in the second width direction B2, and the second guide section 62 guides the article 11 only in second width direction B2. However, the present invention is not limited to such an example, and the first guide section 56 may guide the article 11 in both the second width direction B2 and the second advancing and retracting direction A2, for example. The second guide section 62 may guide the article 11 in both the second width direction B2 and the second advancing and retracting direction A2, for example. For example, the first guide section 56 may be L-shaped guide sections provided at four corners in a top-bottom view. For example, the second guide section 62 may be L-shaped guide sections provided at four corners in a top-bottom view.

(11) Note that the configuration disclosed in the above embodiment can be applied in combination with the configurations disclosed in other embodiments as long as no inconsistency occurs. In terms of other configurations, the embodiment disclosed in the present specification is also just an example in all respects. Accordingly, various modifications can be made appropriately as far as it does not deviate from the scope of this disclosure.

### Outline of Embodiment

The following describes the article transport facility described above.

An article transport facility according to this disclosure includes: a first transfer device including a first fork configured to support an article from a lower side, a first advancing and retracting mechanism configured to advance and retract the first fork along a first advancing and retracting direction along a horizontal direction, and a first lifting and lowering mechanism configured to lift and lower the first fork; and at least one second transfer device including a second fork configured to support the article from the lower side, and a second advancing and retracting mechanism configured to advance and retract the second fork along a second advancing and retracting direction along the horizontal direction. The second fork includes at least one support section with a supporting surface for supporting the article, a fork disposition space disposed below the supporting surface such that the first fork projecting along the first advancing and retracting direction is disposed in the fork disposition space, and a communication section allowing the fork disposition space to communicate with an upper space above the supporting surface in an up-down direction. The first fork is passable through the communication section in the up-down direction. The at least one support section supports the article with a posture in which a supported surface, of the article, that faces downward intersects with a movement trajectory of the first fork passing through the communication section in the up-down direction.

With this configuration, it is possible to transfer the article directly from the first fork of the first transfer device to the second fork of the second transfer device. On that account, it is not necessary to provide a mounting section or the like for placing the article thereon temporarily, between the first transfer device and the second transfer device. Accordingly, it is possible to easily achieve downsizing of the article transport facility and simplification of its configuration.

As one aspect, it is preferable that the at least one support section include a pair of support sections apart from each other to be disposed on respective opposite sides in a first width direction across the communication section, the first width direction being a direction perpendicular to the first advancing and retracting direction in a top-bottom view.

With this configuration, it is possible to support the article by the pair of support sections apart from each other to be disposed on the respective opposite sides in the first width direction. Accordingly, it is possible to easily and stably support the article by the second fork.

As one aspect, it is preferable that: the second fork include a fork body and a delivery assist member attached to the fork body; the delivery assist member include the pair of support sections, a base section apart downward from the pair of support sections, and a pair of connecting sections connecting the pair of support sections to the base section in the up-down direction; the pair of support sections have respective supporting surfaces apart from a top surface of the base section in the up-down direction with a distance larger than a dimension of the first fork in the up-down direction; the pair of connecting sections are apart from each other in the first width direction with a distance larger than a dimension of the first fork in the first width direction, and the pair of support sections are apart from each other in the first width direction with a distance larger than the dimension of the first fork in the first width direction; and the fork disposition space be defined by the pair of support sections, the pair of connecting sections, and the base section.

With this configuration, it is possible to appropriately form the fork disposition space for disposing the first fork and to appropriately form the communication section through which the first fork is passable in the up-down direction. It is possible to form the second fork such that the delivery assist member is attached to the fork body. Accordingly, with the use of a fork of a generally used transfer device as the fork body, for example, it is possible to achieve the aforementioned second transfer device at a low cost.

As one aspect, it is preferable that the second fork include a first guide section attached to the at least one support section to project upward from the supporting surface, the first guide section being configured to guide the article in a horizontal direction, while the article is being placed on the supporting surface from above.

With this configuration, even in a case where the horizontal position of the article deviates from its appropriate position at the time when the article is transferred from the first fork to the second fork, it is possible to guide the article in the horizontal direction to the appropriate position and to support the article by the supporting surface.

As one aspect, it is preferable that: the at least one support section of the second fork and the first fork be configured to deliver or receive the article to or from each other between a pair of fixed members fixed to a floor face and extending in the up-down direction; the pair of fixed members be on respective opposite sides in a second width direction across the at least one support section at a delivery position with respective gaps from the at least one support section, the second width direction being a direction perpendicular to the second advancing and retracting direction in a top-bottom view, the delivery position being a position of the at least one support section of the second fork at which position the at least one support section delivers or receives the article to or from the first fork; the pair of fixed members are provided with respective second guide sections attached thereto; the pair of second guide sections be above the first guide section with the at least one support section being at the delivery position and overlap with the respective gaps in the top-bottom view; and the pair of second guide sections are configured to guide the article, in the second width direction, while the article is being placed on the supporting surface from above.

With this configuration, even in a case where a gap in the second width direction is formed between each of the pair of fixed members and the support section at the delivery position, and the horizontal position of the article deviates to protrude the gap at the time when the article is transferred from the first fork to the second fork, it is possible to guide the article in the horizontal direction to the appropriate position and to support the article by the supporting surface.

As one aspect, it is preferable that: the at least one support section of the second fork and the first fork be configured to deliver or receive the article to or from each other between a pair of fixed members fixed to a floor face and extending in the up-down direction; the pair of fixed members be on respective opposite sides in a second width direction across the at least one support section at a delivery position with respective gaps from the at least one support section, the second width direction being a direction perpendicular to the second advancing and retracting direction in a top-bottom view, the delivery position being a position of the at least one support section of the second fork at which position the at least one support section delivers or receives the article to or from the first fork; and the second transfer device with the at least one support section being stopped at a reference stopping position be wholly in an arrangement region that does not overlap with a region between the pair of fixed members in the top-bottom view, the reference stopping position being a stopping position of the at least one support section at a time of stopping the second transfer device.

With this configuration, even in a case where the floor face shakes due to vibrations caused by an earthquake or the like, it is possible to reduce the possibility that the second transfer device interfere with the fixed member.

As one aspect, it is preferable that: the article transport facility further include a transport device configured to move the first transfer device in at least either of the up-down direction and the horizontal direction; the at least one second transfer device include a plurality of second transfer devices within a moving range where the first transfer device is moved by the transport device; each of the plurality of second transfer devices moves the article received from the first fork to a destination determined in advance to correspond to the each of the plurality of second transfer devices, in response to advancing and retracting of the second fork by the second advancing and retracting mechanism; and the second advancing and retracting mechanism of the each of the plurality of second transfer devices advance and retract the second fork by an advancing and retracting amount set in accordance with the destination and an installation position of the each of the plurality of second transfer devices.

With this configuration, it is possible to move the article to the destination by any of the second transfer devices such that the article held by the first transfer device is transported by the transport device and transferred to the any of the second transfer devices. The second transfer device moves the article from any destination and delivers it to the first transfer device so that the article can be transported to other places. With this configuration, since the advancing and retracting amount of the second fork in the second transfer device is set in accordance with each destination and the installation position of the second transfer device, thereby making it possible to transfer the article by the second transfer device more appropriately in accordance with the arrangement location or the purpose of the second transfer device.

As one aspect, it is preferable that: the article be a prayer target object; the article transport facility further include a transport device configured to move the first transfer device in at least either of the up-down direction and the horizontal direction; the at least one second transfer device be at a position corresponding to a praying section where a visitant prays; the first transfer device and the transport device be configured to transport the prayer target object between the at least one second transfer device and each of a plurality of storing sections each configured to store the prayer target object; and the at least one second transfer device configured to dispose the prayer target object received from the first fork and supported by the at least one support section at an altar position in the praying section in response to advancing and retracting of the second fork by the second advancing and retracting mechanism.

With this configuration, it is possible to move the prayer target object stored in the storing section to the altar position set in the praying section and to move the prayer target object from the altar position to the storing section. With this configuration, it is possible to transfer the article directly from the first fork to the second fork at the time when such a prayer target object is moved and to dispose the prayer target object supported on the second fork directly to the altar position without transferring the prayer target object. Accordingly, it is possible to easily simplify a configuration for movement of the prayer target object and to eventually facilitate maintenance of the facility.

As one aspect, it is preferable that: the article transport facility further include a partition wall between the plurality of storing sections and the altar position; and the at least one support section be closer to the praying section than the partition wall is while the at least one support section stops at a reference stopping position, the reference stopping position being a stopping position of the at least one support section at a time of stopping the at least one second transfer device.

With this configuration, in a case where repair of malfunction or maintenance is performed on the second transfer device, an operator can easily reach the second transfer device from the praying section side relative to the partition wall. Accordingly, repair of malfunction or maintenance is easily facilitated.

What is claimed is:

1. An article transport facility comprising:
a first transfer device comprising:
a first fork configured to support an article from a lower side;
a first advancing and retracting mechanism configured to advance and retract the first fork along a first advancing and retracting direction along a horizontal direction; and
a first lifting and lowering mechanism configured to lift and lower the first fork; and
at least one second transfer device comprising:
a second fork configured to support the article from the lower side; and
a second advancing and retracting mechanism configured to advance and retract the second fork along a second advancing and retracting direction along the horizontal direction, and
wherein:
the second fork comprises:
at least one support section with a supporting surface for supporting the article;
a fork disposition space disposed below the supporting surface such that the first fork projecting along the first advancing and retracting direction is disposed in the fork disposition space; and
a communication section allowing the fork disposition space to communicate with an upper space above the supporting surface in an up-down direction;
the first fork is passable through the communication section in the up-down direction; and
the at least one support section supports the article with a posture in which a supported surface, of the article, that faces downward intersects with a movement trajectory of the first fork passing through the communication section in the up-down direction.

2. The article transport facility according to claim 1, wherein:
the at least one support section comprises a pair of support sections apart from each other to be disposed on respective opposite sides in a first width direction across the communication section, and the first width direction is a direction perpendicular to the first advancing and retracting direction in a top-bottom view.

3. The article transport facility according to claim 2, wherein:
the second fork comprises:
a fork body; and
a delivery assist member attached to the fork body;
the delivery assist member comprises:
the pair of support sections;
a base section apart downward from the pair of support sections; and
a pair of connecting sections connecting the pair of support sections to the base section in the up-down direction;
the pair of support sections have respective supporting surfaces apart from a top surface of the base section in the up-down direction with a distance larger than a dimension of the first fork in the up-down direction;
the pair of connecting sections are apart from each other in the first width direction with a distance larger than a dimension of the first fork in the first width direction;
the pair of support sections are apart from each other in the first width direction with a distance larger than the dimension of the first fork in the first width direction; and
the fork disposition space is defined by the pair of support sections, the pair of connecting sections, and the base section.

4. The article transport facility according to claim 1, wherein:
the second fork comprises a first guide section attached to the at least one support section to project upward from the supporting surface, the first guide section is configured to guide the article in the horizontal direction while the article is being placed on the supporting surface from above.

5. The article transport facility according to claim 4, wherein:
the at least one support section of the second fork and the first fork are configured to deliver or receive the article to or from each other between a pair of fixed members fixed to a floor face and extending in the up-down direction;
the pair of fixed members are on respective opposite sides in a second width direction across the at least one support section at a delivery position with respective gaps from the at least one support section, the second width direction is a direction perpendicular to the second advancing and retracting direction in a top-bottom view, and the delivery position is a position of the at least one support section of the second fork at which position the at least one support section delivers or receives the article to or from the first fork;
the pair of fixed members are provided with respective second guide sections attached thereto,
the second guide sections are above the first guide section with the at least one support section being at the delivery position and overlap with the respective gaps in the top-bottom view; and
the second guide sections are configured to guide the article in the second width direction while the article is being placed on the supporting surface from above the first guide section.

6. The article transport facility according to claim 1, wherein:
the at least one support section of the second fork and the first fork are configured to deliver or receive the article to or from each other between a pair of fixed members fixed to a floor face and extending in the up-down direction;
the pair of fixed members are on respective opposite sides in a second width direction across the at least one support section at a delivery position with respective gaps from the at least one support section, the second width direction is a direction perpendicular to the second advancing and retracting direction in a top-bottom view, and the delivery position is a position of the at least one support section of the second fork at which position the at least one support section delivers or receives the article to or from the first fork; and
the second transfer device with the at least one support section being stopped at a reference stopping position is in an arrangement region that does not overlap with a region between the pair of fixed members in the top-bottom view, the reference stopping position being a stopping position of the at least one support section at a time of stopping the second transfer device.

7. The article transport facility according to claim 1, further comprising:
a transport device configured to move the first transfer device in at least either of the up-down direction and the horizontal direction, and
wherein:
the at least one second transfer device comprises a plurality of second transfer devices within a moving range where the first transfer device is moved by the transport device;
each of the plurality of second transfer devices moves the article received from the first fork to a destination determined in advance to correspond to the each of the plurality of second transfer devices, in response to advancing and retracting of the second fork by the second advancing and retracting mechanism; and
the second advancing and retracting mechanism of the each of the plurality of second transfer devices advances and retracts the second fork by an advancing and retracting amount set in accordance with the destination and a position of the each of the plurality of second transfer devices.

8. The article transport facility according to claim 1, wherein:
the article is a prayer target object;
the article transport facility further comprises a transport device configured to move the first transfer device in at least either of the up-down direction and the horizontal direction;
the at least one second transfer device is at a position corresponding to a praying section where a visitant prays;
the first transfer device and the transport device are configured to transport the prayer target object between the at least one second transfer device and each of a plurality of storing sections each configured to store the prayer target object; and
the at least one second transfer device is configured to dispose the prayer target object received from the first fork and supported by the at least one support section at an altar position in the praying section in response to advancing and retracting of the second fork by the second advancing and retracting mechanism.

9. The article transport facility according to claim 8, further comprising:
a partition wall between the plurality of storing sections and the altar position, and
wherein the at least one support section is closer to the praying section than the partition wall is while the at least one support section stops at a reference stopping position, and the reference stopping position is a stopping position of the at least one support section at a time of stopping the at least one second transfer device.
